(19) United States
(12) Patent Application Publication
(10) Pub. No.: US 2026/0057369 A1
(43) Pub. Date: Feb. 26, 2026

(54) PAYMENT SYSTEM UTILIZING A CONSUMER DEVICE FOR APPROVAL PROCESSING

(71) Applicant: Mastercard International Incorporated, Purchase, NY (US)

(72) Inventors: Lalit Manchanda, River Vale, NJ (US); Ajay Sinha, Pune (IN); Naveen Kumar Gupta, Pune (IN)

(21) Appl. No.: 18/811,839

(22) Filed: Aug. 22, 2024

(51) Int. Cl. G06Q 20/32

(52) U.S. Cl. CPC G06Q 20/3278; G06Q 20/3226

(57) ABSTRACT

A payment system is provided for completing purchases using a consumer device like a smartphone. Once a consumer selects a product or good to purchase, payment data is transmitted from a frontend terminal to the consumer device over a first wireless connection. The payment data is then relayed to a backend kernel and/or payment network preferably over a second wireless connection. The first wireless connection may be an NFC connection, and the second wireless connection may be a cellular network. Once the purchase is approved, an approval message may be transmitted and relayed back to the frontend terminal over the first and second wireless connections.

### BACKGROUND

The present inventions relate generally to financial transaction processing, and more particularly, to a system that utilizes a consumer's device for authorization processing of a purchase.

Modern consumer payment systems commonly utilize sophisticated transaction systems involving one financial institution associated with the consumer (issuer), another financial institution associated with the merchant (acquirer) and a payment network (e.g., Mastercard, Visa, Discover, American Express) that facilitates payments from the issuer to the acquirer. Such payment systems have traditionally used physical cards (e.g., credit and debit cards) as a means for initiating and authorizing a purchase. However, there has been a move to substitute a consumer's smartphone for traditional physical cards since a consumer's smartphone can now be used as a digital wallet containing the consumer's card information without needing to actually carry a traditional physical card with the consumer.

Because modern consumer payment systems have become so ubiquitous and convenient, such payment systems are now the most common way for consumers to pay for purchases of products and services. However, the success of modern consumer payment systems can create problems in some scenarios. That is, consumers have begun to expect that they should be able to use their credit or debit account to pay for any product or service that the consumer wishes to purchase.

However, because modern consumer payment systems are quite technically complex, there are still some situations where merchants are not setup to accept credit or debit card purchases. Thus, when a consumer encounters such a merchant, the consumer may not be able to complete a purchase from the merchant. This leaves the consumer disappointed and causes the merchant to lose a potential sale.

Thus, the inventors believe it would be desirable to make it easier for consumers to use modern consumer payment systems in situations where such systems are not currently being used.

### SUMMARY

A payment system is described which may allow purchases to be made in more locations and situations than is currently possible. The payment system preferably uses the consumer's smartphone as a proxy for communication between a frontend terminal and a backend kernel. That is, a first wireless connection may be established between the consumer's smartphone and the frontend terminal, and a second wireless connection may be established between the consumer's smartphone and the backend kernel. This may allow purchases to be made with the frontend terminal even if the frontend terminal does not have an independent communication connection with the backend kernel. It may also be desirable for the consumer's smartphone to wirelessly supply electrical power to the frontend terminal so that purchases may be made with the frontend terminal even when the frontend terminal is not independently supplied with electrical power. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawing, in which:

FIG. 1 illustrates a schematic of a payment system showing card issuers, payment networks and acquirers;

FIG. 2 illustrates a schematic of a payment system showing a card issuer, payment network, acquirer, consumer and merchant;

FIG. 3 illustrates a schematic of a payment system showing a consumer device, vending device, frontend terminal, backend kernel and a payment network; and

FIG. 4 illustrates a block diagram of the consumer device, vending device, frontend terminal, backend kernel and a payment network.

### DETAILED DESCRIPTION

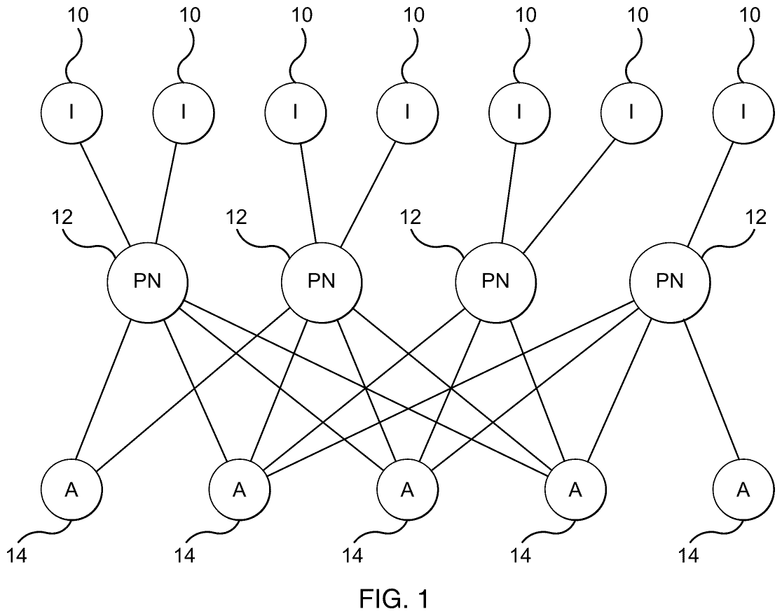

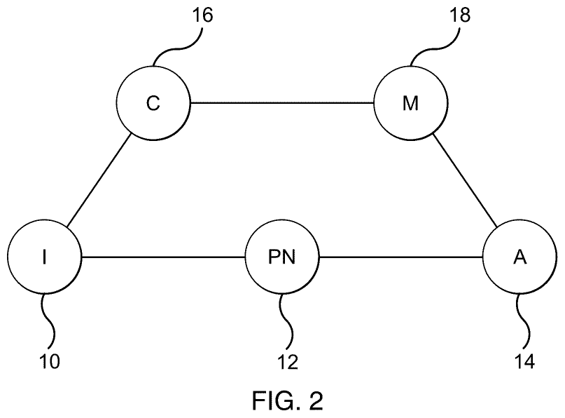

Referring now to the figures, and particularly FIG. 1, a schematic of a payment processing system is shown. As shown, the system typically involves three entities—card issuers 10, payment networks 12 and acquirers 14 (in addition to consumers 16 and merchants 18, see FIG. 2). The payment networks 12 are companies, such as MasterCard, Visa, Discover and American Express, that process financial transactions between the card issuers 10 and the acquirers 14. Typically, the card issuer 10 is associated with one of the payment networks 12, and each of the payment networks 12 are associated with multiple card issuers 10 who issue cards to consumers 16 that are associated with the particular payment network 12. However, it is understood that some card issuers 10 may issue cards to its consumers 16 from more than one of the payment networks 12. Each of the acquirers 14 typically accept financial transactions processed through multiple payment networks 12. However, it is possible for an acquirer 14 to choose to only process transactions from particular payment networks 12 if desired. As explained below, some of the functions of the acquirer 14 may be performed by a separate third party payment processor, such as the backend kernel 26 described below. However, this possibility does not eliminate the acquirers 14 from the system since at a minimum financial funds are ultimately transferred from card issuers 10 to acquirers 14 to satisfy purchase payments between consumers 16 and the merchants 18. This also means that the acquirers 14 must be provided access by any such payment processors to payment data for their merchants 18 in order to manage financial receipts. Although FIG. 1 illustrates a limited number of card issuers 10 and acquirers 14, it is understood that the number of card issuers 10 and acquirers 14 in such a system typically measure in the thousands. By contrast, there are a relatively few number of payment networks 12.

Turning to FIG. 2, a simpler schematic is shown which also includes consumers 16 and merchants 18. It is understood that a completed diagram like this would be impossible to show because the number of cardholders 16 (i.e., consumers 16) and merchants 18 can number in the millions. Even so, it can be seen that in a typical credit card processing system that the consumer 16 primarily interacts with the card issuer 10 and a merchant 18. That is, the cardholder 16 keeps a credit or debit card account with the card issuer 10 and traditionally retains a physical credit or debit card which was issued by the card issuer 10 that the consumer 16 then uses to authorize various financial transactions. The underlying financial transactions are initiated by the consumer 16 by purchasing goods or services from a merchant 18 and authorizing payment for the goods or services using the credit or debit card issued by the card issuer 10. The card issuer 10 later issues a statement to the consumer 16 and receives payment from the consumer 16 to cover the financial transactions authorized by the consumer 16.

The merchant 18 principally interacts with an acquirer 18, in addition to interacting with the consumer 16 to sell the goods or services. Once the purchase is complete, the merchant 18 provides the purchase details to the acquirer 14, including at least the financial amount of the transaction and the credit card number used by the consumer 16 to authorize the purchase. The acquirer 18 then submits the financial transaction to the payment network 12 associated with the credit or debit card used by the consumer 16. The payment network 12 then processes the financial transaction and facilitates the transfer of financial funds from the card issuer 10 to the acquirer 14 to satisfy the financial transaction. It is understood that in such a system with millions of consumers 16 and merchants 18 and thousands of card issuers 10 and acquirers 14 that the system must be able to process millions of financial transactions on a constant basis and that such credit card processing can only be accomplished using automated computer systems usually involving computer servers employing multiple computer processors and computer memory storing the computer instructions which cause the processors to automatically process millions of financial transactions.

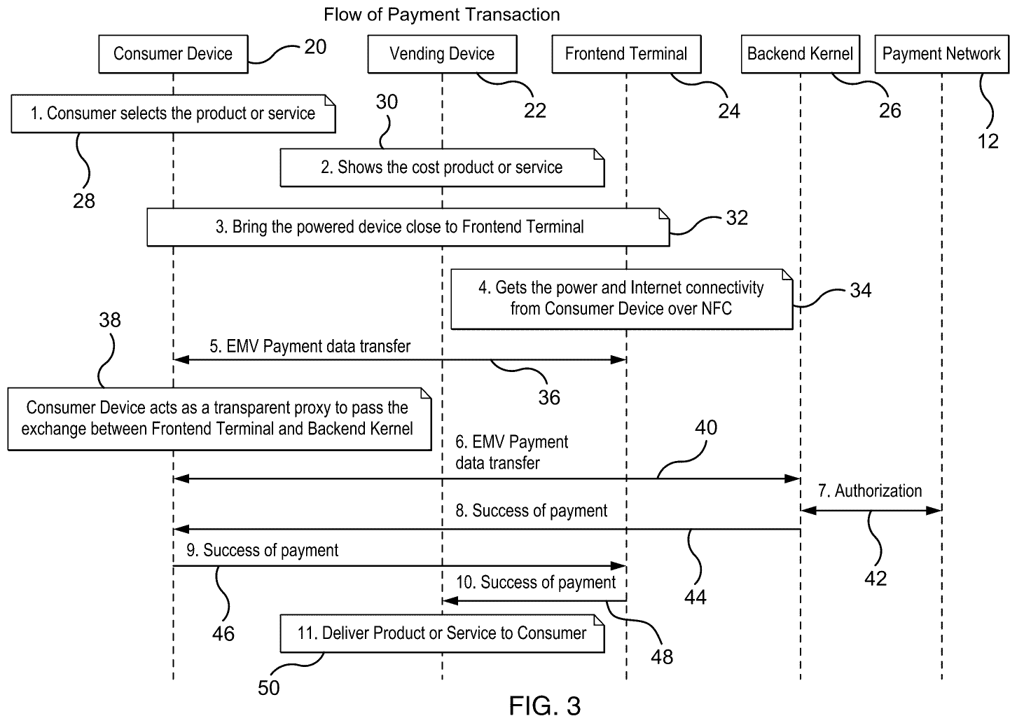

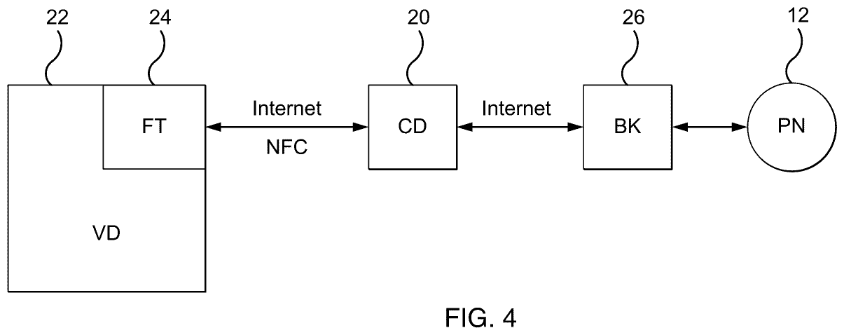

Turning to FIGS. 3-4, the improved payment system may include a consumer device 20, a vending device 22, a frontend terminal 24, a backend kernel 26 and a payment network 12. The consumer device 20 is an electronic device 20 in the possession of the consumer 16 like a smartphone 20. Preferably, the consumer device 20 is wirelessly connected to the internet through, for example, a cellular network. The consumer device 20 is also preferably connected to an electrical power supply, such as an onboard battery. Even more preferably, the consumer device 20 can be wirelessly connected to other electronic devices through short range communications protocols, such as NFC.

The vending device 22 holds products for sale or controls the dispensing of a service that a consumer 16 may wish to purchase. Upon receiving purchase approval through the other components of the system, the vending device 22 releases the purchased product or service to the consumer 16. However, it is noted that control over releasing a purchased good or service to the consumer 16 may be accomplished in other ways as well without implementing a vending device 22.

The frontend terminal 24 is typically in the possession of the merchant 18. When purchasing a product or service, the consumer 16 interacts with the frontend terminal 24 by providing payment data to the frontend terminal 24. Historically, the frontend terminal 24 would be a credit/debit card reader using either a magnetic strip or an embedded chip on credit/debit cards. However, as described below, the frontend terminal 24 in the present invention may be considerably stripped down in its capabilities compared to conventional card readers. If desired, the frontend terminal 24 may be physically incorporated into the vending device 22 such that the vending device 22 releases the product or good to the consumer 16 in response to an electrical signal or other physical control from the frontend terminal 24 after the frontend terminal 24 has received an approval message for the purchase.

The backend kernel 26 will typically be a remote server system that is accessible by numerous frontend terminals 24 through the internet. The backend kernel 26 may include some of the functions of the acquirers 14 described above and may be viewed as a type of third-party payment processor—even though the backend kernel 26 may actually be managed by one or more of the payment networks 12.

As described above, the payment network 12 processes financial transactions between card issuers 10 and acquirers 14 (or the backend kernel 26). For the sake of simplicity, FIGS. 3-4 show only one payment network 12, but in practice, it is preferable for the system to work seamlessly with all of the major payment networks 12 (i.e., MasterCard, Visa, Discover and American Express). Thus, the backend kernel 26 preferably recognizes what payment network 12 the consumer's form of payment is associated with and directs authorization communications to whichever payment network 12 the form of payment is associated with.

To purchase a product or service using the improved system, the consumer 16 begins by selecting the product or service that the consumer 16 wishes to purchase (28). This may be done by making a selection at the vending device 22 or simply by orally communicating with a human merchant 18. The consumer 16 is also informed of the cost of the product or service by the vending device 22 or the human merchant 18 (30).

Once the consumer selection and cost are agreed to, the consumer device 20 may be used to establish a first wireless connection between the consumer device 20 and the frontend terminal 24 (34). In the preferred embodiment, the frontend terminal 24 may not be independently connected to the internet like conventional frontend terminals. Thus, unlike a conventional frontend terminal, the frontend terminal 24 preferred in the present invention may not be able to directly communicate with the backend kernel 26 (or acquirer 14), payment network 12, etc. Instead, as described, the consumer device 20 may be used as a proxy between the frontend terminal 24 and the backend kernel 26/payment network 12. It is understood that a special software app will typically need to be loaded onto the consumer's smartphone 20 to enable the consumer's smartphone 20 to be used as a communications proxy. More preferably, communication between the frontend terminal 24 and the consumer device 20 and between the consumer device 20 and the backend kernel 26/payment network 12 uses an Internet Protocol (IP). With respect to the first wireless connection between the consumer device 20 and the frontend terminal 24, this connection may be initiated by the consumer device 20 using Near Field Communication (NFC). Even more specifically, communication between the consumer device 20 and the frontend terminal 24 (i.e., both the payment data transmitted from the frontend terminal 24 to the consumer device 20 and the approval message relayed from the consumer device 20 to the frontend terminal 24) preferably utilizes IP over NFC according to IETF (Internet Engineering Task Force) RFC 9428.

Additionally, in the present invention, it is possible for the frontend terminal 24 to be electrically unpowered by a wired connection or a battery that would normally power the terminal 24. Instead, the consumer device 20 may provide electrical power to the frontend terminal 24 to operate a computer processor and other electronics in the frontend terminal 24 needed to process the consumer's payment data (34). Preferably, this is done using the NFC wireless connection discussed above. It is understood that this will require the consumer 16 to place the consumer device 20 relatively close to the frontend terminal 24 in order to transfer electrical power to the frontend terminal 24 (in addition to payment authorization communications exchanged therebetween) (32). Thus, in the preferred embodiment, the frontend terminal 24 may be both unconnected to the internet and may be electrically unpowered. As a result, the frontend terminal 24 may be used in many places where conventional frontend terminals will not work. Thus, by utilizing the present invention, consumers 16 may be able to use credit/debit accounts to complete purchases in many more places and circumstances.

When the frontend terminal 24 receives internet connectivity and electrical power from the consumer device 20 in the preferred embodiment, the consumer device 20 preferably transmits a credit or debit number associated with a financial account owned by the consumer 16 along with other conventional payment data (e.g., name, credit or debit card number, expiration date, CVV) (36). For example, the consumer device 20 may generate a transaction specific cryptogram containing the payment data and transmit it to the frontend terminal 24 via a first logical channel created by the NFC wireless connection between the consumer device 20 and the frontend terminal 24. The frontend terminal 24 then responds by transmitting payment data from the frontend terminal to the consumer device 20 over the first wireless connection (36). For example, the frontend terminal 24 may establish a second logical channel over the NFC first wireless connection between the frontend terminal 24 and the consumer device 20. The frontend terminal 24 may then encrypt and envelope the cryptogram which was transmitted by the consumer device 20 into one or more APDUs (Application Protocol Data Unit) which are transmitted to the consumer device 20 over the second logical channel. Preferably, the first and second logical channels are isolated and discrete from each other. This is useful to prevent spoofing or other similar fraudulent attempts to fake purchase authorizations or other attempts to steal data. It is understood that the payment data that is initially transmitted from the consumer device 20 to the frontend terminal 24 may be similar to the payment data sent back from the frontend terminal 24 to the consumer device 20, but the two transmissions of payment data will typically not be the same as each other. That is, the payment data sent from the frontend terminal 24 to the consumer device 20 will typically include most if not all of the payment data transmitted from the consumer device 20 to the frontend terminal 24 (e.g., name, credit or debit card number, expiration date, CVV) but will also typically include additional payment data as well like the purchase amount, an ID for the frontend terminal 24, etc. Preferably, the payment data transmitted from the frontend terminal 24 to the consumer device 20 (e.g., APDUs) are encrypted in a way that is only decipherable by the backend kernel 26 and is inaccessible by the consumer device 20 (38). For example, the frontend terminal 24 may generate an asymmetric key pair and may exchange the public key with the backend kernel 26. The public key may also be used to encrypt the approval message sent back from the backend kernel 26 to the frontend terminal 24.

When the consumer device 20 receives the payment data from the frontend terminal 24, the payment data is then relayed to the backend kernel 26 and the payment network 12 (40). As noted, this is preferably done without the consumer device 20 having any access to the contents of the payment data (38). In the preferred embodiment, the payment data is relayed from the frontend terminal 24 to the consumer device 20 over a second wireless connection. The second wireless connection preferably uses the cellular network that the consumer's smartphone 20 is already connected to and uses encrypted Internet Protocol (IP) for communication.

As noted, in the preferred embodiment, the frontend terminal 24 may not have an independent electrical power supply. Thus, it is preferred for the frontend terminal 24 to be designed to only perform a minimal amount of data processing. Because of this, some data processing functions that would normally be performed by a conventional card reader may be shifted from the frontend terminal 24 to the backend kernel 26. For example, conventional card readers typically determined which payment network 12 each purchase attempt is associated with and transmits the payment data to whichever payment network 12 the consumer's form of payment is associated with. However, in the preferred embodiment, these types of functions may be performed by the backend kernel 26. Thus, in addition to other possible data processing that the backend kernel 26 may perform on the payment data, the backend kernel 26 may determine which of several payment networks 12 the payment data is associated with. The backend kernel 26 may then redirect the payment data to the payment network 12 associated with the payment data (42). Preferably, the backend kernel 26 also decrypts the payment data prior to transmitting it to the respective payment network 12.

Once the payment network 12 receives the payment data, the payment network 12 reviews the payment data and any other relevant data and approves or denies the purchase attempt using conventional processes. Assuming the purchase attempt is approved, the payment network 12 then transmits an approval message to the backend kernel 26 (42) which is forwarded to the consumer device 20 over the second wireless connection (44). The approval message is then relayed by the consumer device 20 to the frontend terminal 24 over the first wireless connection (46). Like the payment data transmitted from the frontend terminal 24, it is preferable for the approval message to be encrypted as it is transmitted from the backend kernel 26 to the consumer device 20 and as it is relayed from the consumer device 20 to the frontend terminal 24. Likewise, it is preferable for the approval message to be inaccessible by the consumer device 20. That is, the consumer device 20 may be used as a proxy for communication between the backend kernel 26 and the frontend terminal 24.

When the frontend terminal 24 receives the approval message, the merchant 18 may then deliver the product or service to the consumer 16 (50). For example, where the frontend terminal 24 is incorporated into a vending device 22, the frontend terminal 24 may send an electrical signal or other physical control to the vending device 22 to release the product or service to the consumer 16 (48). The described payment system may also be useful for delivery agents who collect card payments on delivery of a product (e.g., pizza delivery) or a service. In such cases, the delivery agent may suffer from poor internet service for their frontend terminal 24. However, with the described payment system, the delivery agent may be able to complete the payment utilizing the consumer's own internet service. Remote locations, with or without use of an integrated vending device 22, may also be a useful area to use the described payment system if consumers 16 are able to receive internet service to their own devices 20. Another advantage of the described payment system is that merchants 18 may be able to save costs by not paying for their own internet service and/or electrical power when using the described payment system.

It is understood that the described payment system is intended to operate autonomously on programmed computer systems utilizing computer algorithms such that the system may be implemented multiple computer processors executing computer-executable instructions stored on a non-transitory computer-readable storage medium. Thus, for example, in the case of the consumer device 20, vending device 22, frontend terminal 24, backend kernel 26, payment networks 12 and the steps described herein, it is unnecessary for human beings to make the required data transmissions, determinations, etc. This autonomous design makes the payment system scalable to a level that would be impractical if human beings were to attempt to perform the steps required by the system. While it is understood that various human beings may provide inputs to the system and may adjust parameters that control how the system operates, the payment system is intended to have the capability of processing many thousands of purchases in short periods of time (e.g., seconds or less) that would be impossible to accomplish with human intervention in each transaction.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A method for a consumer to purchase a product or service, comprising:
selecting the product or service to purchase by the consumer;
establishing a first wireless connection between a consumer device and a frontend terminal;
transmitting payment data from the frontend terminal to the consumer device over the first wireless connection;
relaying the payment data from the consumer device to a payment network;
approving the purchase of the product or service by the payment network using the payment data;
transmitting an approval message from the payment network to the consumer device;
relaying the approval message from the consumer device to the frontend terminal over the first wireless connection; and
providing the product or service to the consumer based on the approval message being received by the frontend terminal.

2. The method according to claim 1, wherein the payment data is transmitted from the frontend terminal to the consumer device over the first wireless connection using Internet Protocol (IP).

3. The method according to claim 2, wherein the payment data is transmitted from the frontend terminal to the consumer device using IP over NFC according to RFC 9428.

4. The method according to claim 1, wherein the approval message is relayed from the consumer device to the frontend terminal over the first wireless connection using Internet Protocol (IP).

5. The method according to claim 4, wherein the approval message is relayed from the consumer device to the frontend terminal using IP over NFC according to RFC 9428.

6. The method according to claim 1, wherein the consumer device is used as a proxy between the frontend terminal and the payment network for Internet Protocol (IP) traffic therebetween for relaying the payment data and the approval message.

7. The method according to claim 1, wherein the frontend terminal comprises a computer processor for processing the payment data, the frontend terminal being electrically unpowered by a wired connection or a battery to power the computer processor, and the frontend terminal receiving electrical power wirelessly from the consumer device to operate the computer processor.

8. The method according to claim 1, wherein the frontend terminal is not independently connected to the internet.

9. The method according to claim 1, wherein the payment data is relayed from the consumer device to the payment network and the approval message is transmitted from the payment network to the consumer device over a second wireless connection.

10. The method according to claim 9, wherein the second wireless connection is a cellular network.

11. The method according to claim 9, wherein the payment data is relayed and the approval message is transmitted between the consumer device and the payment network using Internet Protocol (IP).

12. The method according to claim 1, wherein the payment data is relayed from the consumer device to a backend kernel, the backend kernel determining which of several payment networks the payment data is associated with, and the backend kernel redirecting the payment data to the payment network associated with the payment data.

13. The method according to claim 12, wherein the backend kernel receives the approval message from the payment network associated with the payment data and transmits the approval message to the consumer device.

14. The method according to claim 1, wherein the payment data is encrypted and inaccessible by the consumer device.

15. The method according to claim 1, wherein the approval message is encrypted and inaccessible by the consumer device.

16. The method according to claim 1, wherein the consumer device is a smartphone.

17. The method according to claim 1, wherein the payment data includes a credit or debit card number.

18. The method according to claim 1, further comprising transmitting a credit or debit card number from the consumer device to the frontend terminal over the first wireless connection.

19. The method according to claim 1, wherein the frontend terminal is incorporated into a vending device, the vending device providing the product or service to the consumer in response to the frontend terminal.

20. The method according to claim 1, wherein the consumer device transmits initial payment data to the frontend terminal via a first logical channel over the first wireless connection, the payment data transmitted from the frontend terminal to the consumer device and relayed to the payment network containing the initial payment data and additional payment data, the payment data being transmitted from the frontend terminal to the consumer device via a second logical channel over the first wireless connection, the first and second logical channels being isolated and discrete from each other.
